(19) United States
(12) Patent Application Publication
(10) Pub. No.: US 2024/0397551 A1
(43) Pub. Date: Nov. 28, 2024

(54) Triggered TXOP Sharing (TXS) Procedure for Multiple Users

(71) Applicant: Ofinno, LLC, Reston, VA (US)

(72) Inventors: Jeongki Kim, Fairfax, VA (US); Kiseon Ryu, McLean, VA (US); Esmael Hejazi Dinan, McLean, VA (US); Leonardo Alisasis Lanante, Reston, VA (US)

(73) Assignee: Ofinno, LLC, Reston, VA (US)

(21) Appl. No.: 18/794,073

(22) Filed: Aug. 5, 2024

Related U.S. Application Data
(63) Continuation of application No. PCT/US2023/012257, filed on Feb. 3, 2023.
(60) Provisional application No. 63/307,250, filed on Feb. 7, 2022.

(51) Int. Cl. H04W 74/0816; H04W 72/0446; H04W 74/08

(52) U.S. Cl. CPC H04W 74/0816; H04W 72/0446; H04W 74/0866

(57) ABSTRACT

An access point (AP) transmits a first frame indicating, for a first station (STA), a first time allocation of a transmission opportunity (TXOP) and a first triggered TXOP sharing (TXS) mode, and for a second STA, a second time allocation of the TXOP and a second TXS mode. The first TXS mode and the second TXS mode may be the same or different. The AP receives from the first STA a second frame within the first time allocation in response to the first frame. The AP receives from the second STA a third frame within the second time allocation in response to the first frame.

### CROSS-REFERENCE TO RELATED APPLICATIONS

This application is a continuation of International Application No. PCT/US2023/012257, filed Feb. 3, 2023, which claims the benefit of U.S. Provisional Application No. 63/307,250, filed Feb. 7, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of target wake time (TWT) operation.

FIG. 4 illustrates an example of TWT operation in an environment including an AP multi-link device (AP MLD) and a station multi-link device (STA MLD).

FIG. 5 illustrates an example TWT element which may be used to support individual TWT operation.

FIG. 6 illustrates an example TWT element which may be used to support restricted TWT (r-TWT) operation.

FIG. 7 illustrates an example of individual TWT operation.

FIG. 8 illustrates an example of broadcast TWT operation.

FIG. 9 illustrates an example of TWT protection in individual TWT operation.

FIG. 10 illustrates an example of a triggered TXOP sharing (TXS) procedure (Mode=1).

FIG. 11 illustrates an example of a TXS procedure (Mode=2).

FIG. 12 is an example diagram of an MU-RTS trigger frame which may be used in a TXS procedure.

FIG. 13 illustrates an example of a TXS procedure for allocating time within an obtained TXOP to multiple STAs.

FIG. 14 illustrates an example of a TXS procedure for allocating time within an obtained TXOP to multiple STAs, with a respective triggered TXOP sharing mode indicated per STA.

FIG. 15 illustrates an example of MU-RTS TXS trigger frame which may be used in a TXS procedure for allocating time within an obtained TXOP to multiple users.

FIG. 16 illustrates another example MU-RTS trigger frame which may be used in a TXS procedure for allocating time within an obtained TXOP to multiple users.

FIG. 17 illustrates another example MU-RTS trigger frame which may be used in a TXS procedure for allocating time within an obtained TXOP to multiple users.

FIG. 18 illustrates a flowchart of a process which may be used by an AP in a TXS procedure. The AP may be affiliated with an AP MLD.

FIG. 19 illustrates a flowchart of a process which may be used by a STA in a TXS procedure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

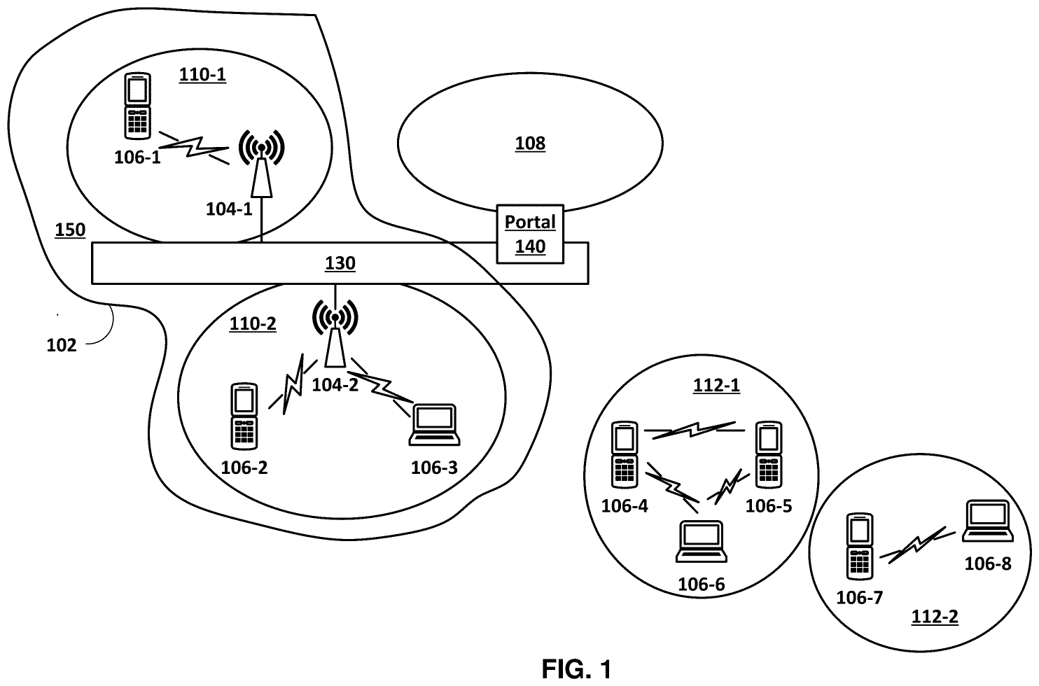

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

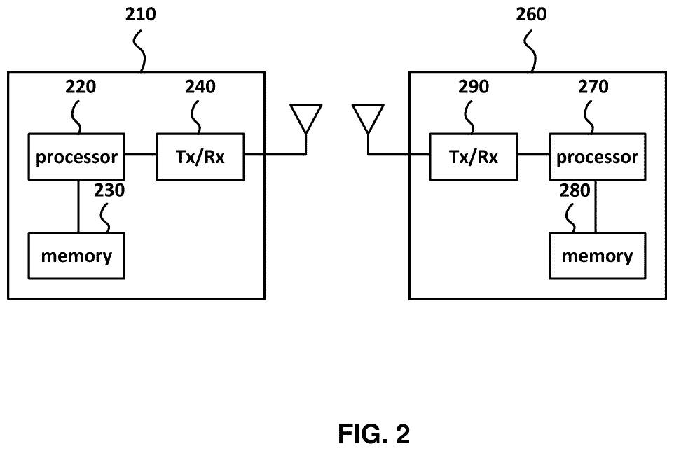

FIG. 2 is a block diagram illustrating example implementations of a STA 210 and an AP 260.

As shown in FIG. 2, STA 210 may include at least one processor 220, a memory 230, and at least one transceiver 240. AP 260 may include at least one processor 270, memory 280, and at least one transceiver 290. Processor 220/270 may be operatively connected to transceiver 240/290.

Transceiver 240/290 may be configured to transmit/receive radio signals. In an embodiment, transceiver 240/290 may implement a PHY layer of the corresponding device (STA 210 or AP 260).

In an embodiment, STA 210 and/or AP 260 may be a multi-link device (MLD), that is a device capable of operating over multiple links as defined by the IEEE 802.11be standard amendment. As such, STA 210 and/or AP 260 may each have multiple PHY layers. The multiple PHY layers may be implemented using one or more of transceivers 240/290.

Processor 220/270 may implement functions of the PHY layer, the MAC layer, and/or the logical link control (LLC) layer of the corresponding device (STA 210 or AP 260).

Processor 220/270 and/or transceiver 240/290 may include application specific integrated circuit (ASIC), other chipset, logic circuit and/or data processor. Memory 230/280 may include read-only memory (ROM), random access memory (RAM), flash memory, memory card, storage medium and/or other storage unit.

When the embodiments are executed by software, the techniques (or methods) described herein can be executed with modules (e.g., processes, functions, and so on) that perform the functions described herein. The modules can be stored in memory 230/280 and executed by processor 220/270. Memory 230/280 may be implemented (or positioned) within processor 220/270 or external to processor 220/270. Memory 230/280 may be operatively connected to processor 220/270 via various means known in the art.

Target wake time (TWT), a feature introduced in the IEEE 802.11ah standard, allows STAs to manage activity in the BSS by scheduling STAs to operate at different times to reduce contention. TWTs may allow STAs to reduce the required amount of time that a STA utilizing a power management mode may be awake. TWTs may be individual TWTs or broadcast TWTs. Individual TWTs follow a negotiated TWT agreement between STAs. Broadcast TWTs are based on a schedule set and provided to STAs by an AP.

In an individual TWT, a STA that requests a TWT agreement is called a TWT requesting STA. The TWT requesting STA may be a non-AP STA for example. The STA that responds to the request is called a TWT responding STA. The TWT responding STA may be an AP for example. The TWT requesting STA is assigned specific times to wake up and exchange frames with the TWT responding STA. The TWT requesting STA may communicate wake scheduling information to the TWT responding STA. The TWT responding STA may transmit TWT values to the TWT requesting STA when a TWT agreement is established between them.

When explicit TWT is employed, the TWT requesting STA may wake up and perform a frame exchange. The TWT requesting STA may receive a next TWT information in a response from the TWT responding STA. When implicit TWT is used, the TWT requesting STA may calculate a next TWT by adding a fixed value to the current TWT value.

The TWT values for implicit TWT may be periodic. The TWT requesting STA operating with an implicit TWT agreement may determine a next TWT service period (TWT SP) start time by adding a value of a TWT wake interval associated with the TWT agreement to the value of the start time of the current TWT SP. The TWT responding STA may include the start time for a series of TWT SPs corresponding to a single TWT flow identifier of an implicit TWT agreement in a target wake time field of a TWT element. The TWT element may contain a value of ‘accept TWT’ in a TWT setup command field. The start time of the TWT SP series may indicate the start time of a first TWT SP in the series. Start times of subsequent TWT SPs may be determined by adding the value of the TWT wake interval to the start time of the current TWT SP. In an example, the TWT requesting STA, awake for an implicit TWT SP, may enter a doze state after the TWT SP has elapsed or after receiving an end of service period (EOSP) field equal to 1 from the TWT responding STA, whichever occurs first.

A TWT session may be negotiated between an AP and a STA. The TWT session may configure a TWT SP of DL and UL traffic between the AP and the STA. Expected traffic may be limited within the negotiated SP. The TWT SP may start at a specific time. The TWT SP may run for a SP duration. The TWT SP may repeat every SP interval.

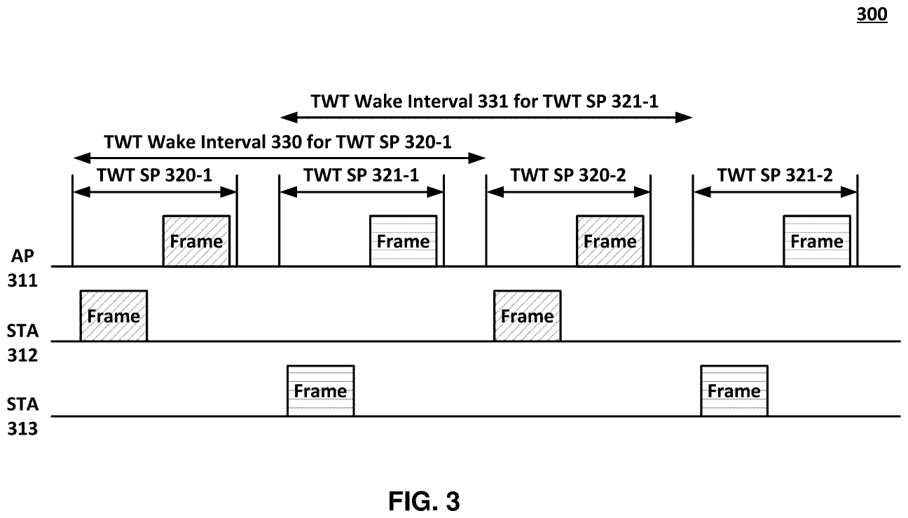

FIG. 3 illustrates an example 300 of TWT operation. As shown in FIG. 3, example 300 includes an AP 311, a STA 312, and a STA 313. AP 311 and STA 312 may establish a TWT SP 320. AP 311 and STA 313 may establish a TWT SP 321. TWT SP 320 and TWT SP 321 may repeat as shown in FIG. 3, such that TWT SP 320 may include a first TWT SP 320-1 and a second TWT SP 320-2, and such that TWT SP 321 may include a first TWT SP 321-1 and a second TWT SP 321-2.

AP 311 and STA 312 may exchange frames during first TWT SP 320-1. STA 312 may enter a doze state at the end of TWT SP 320-1 and may remain in the doze state until the start of second TWT SP 320-2. The start of second TWT SP 320-2 may be indicated by a TWT wake interval 330 associated with TWT SP 320. AP 311 and STA 312 may again exchange frames during second TWT SP 320-2.

Similarly, AP 311 and STA 313 may exchange frames during first TWT SP 321-1. STA 313 may enter a doze state at the end of first TWT SP 321-1 and may remain in the doze state until the start of second TWT SP 321-2. The start of second TWT SP 321-2 may be indicated by a TWT wake interval 331 associated with TWT SP 321. AP 311 and STA 313 may again exchange frames during second TWT SP 31-2.

In an awake state, a STA may be fully powered. The STA may transmit and/or receive a frame to/from an AP or another STA. In a doze state, a STA may not transmit and may not receive a frame to/from an AP or another STA.

An MLD is an entity capable of managing communication over multiple links. The MLD may be a logical entity and may have more than one affiliated station (STA). The MLD may have a single MAC service access point (MAC-SAP) to the LLC layer, which includes a MAC data service. An MLD may be an access point MLD (AP MLD) when a STA affiliated with the MLD is an AP STA (or an AP). An MLD may be a non-access point MLD (non-AP MLD) or STA MLD when a STA affiliated with the MLD is a non-AP STA (or a STA).

During negotiation of TWT agreements, a TWT requesting STA affiliated with a STA MLD and a TWT responding STA affiliated with an AP MLD may communicate multiple TWT elements. The TWT elements may comprise link ID bitmap subfields indicating different link(s) in a TWT setup frame. The TWT parameters provided by a TWT element may be applied to the respective link that is indicated in the TWT element.

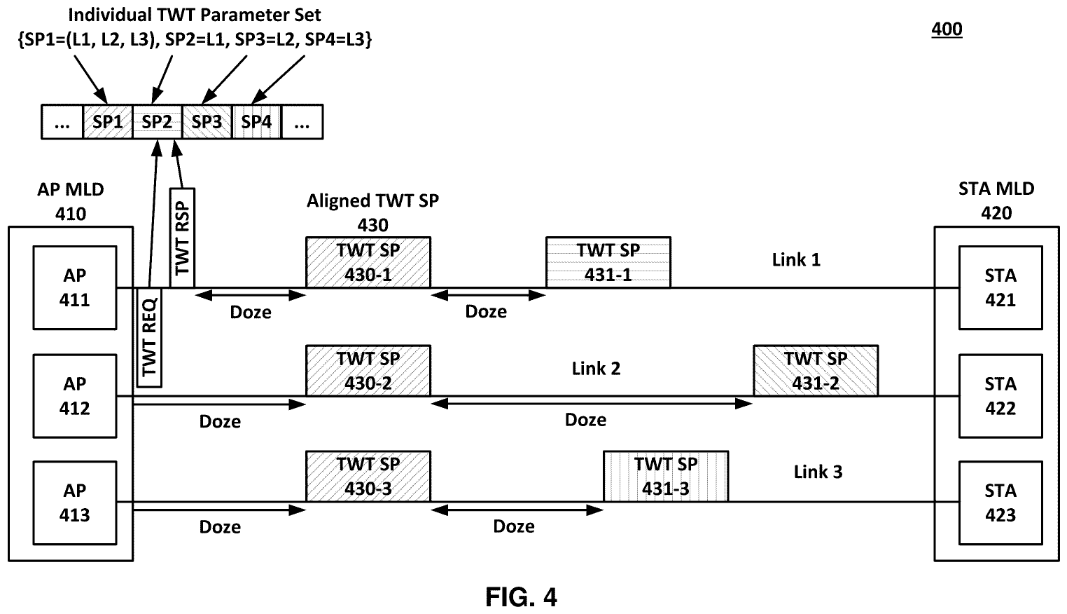

FIG. 4 illustrates an example 400 of TWT operation in a multi-link environment including an AP multi-link device (AP MLD) 410 and a STA multi-link device (STA MLD) 420. As shown in FIG. 4, AP MLD 410 may have three affiliated APs, AP 411, AP2 412, and AP3 413. In an example, AP 411, AP2 412, and AP3 413 may operate respectively on the 2.4 GHz band, the 5 GHz band, and the 6 GHz band. STA MLD 420 may have three affiliated STAs, STA 421, STA 422, and STA 423. In an example, STA 421, STA 422, and STA 423 may operate respectively on the 2.4 GHz band, the 5 GHz band, and the 6 GHz band. In an example, AP 411, AP2 412, and AP3 413 may be communicatively coupled via a first link (link 1), a second link (link 2), and a third link (link 3) respectively with STA 421, STA 422, and STA 423, respectively.

In an example, STA 421 may transmit a TWT request to AP 411. The TWT request may include three TWT elements. Each TWT element may indicate a respective link of links 1-3 and may request the setup of a TWT agreement for the indicated link. The three TWT elements may have different TWT parameters, such as target wake time (TWT). In response to the TWT request, AP 411 may transmit a TWT response to STA 421. The TWT response may include three TWT elements. Each TWT element may indicate a respective link of links 1-3 and may include a value of ‘accept TWT’ in a TWT setup command field.

Successful TWT agreement setup on links 1-3 establishes three TWT SPs with same or different TWT parameters on links 1-3 respectively. The target wake time field of the TWT element indicating a given link indicates the start time of the TWP SP for that link. The starting time may be indicated in reference to a time synchronization function (TSF) time of the link.

In example 400, initial TWT SPs 430-1, 430-2, and 430-3 of links 1-3 respectively may be aligned. TWT wake intervals associated with the TWT agreements of links 1-3 respectively may be set differently. As such, second TWT SPs 431-1, 431-2, and 431-3 of links 1-3 respectively may not be aligned. STA 421, STA 422, and STA 423 may enter a doze state between the end of initial TWT SPs 430-1, 430-2, and 430-3, respectively, and the start of second TWT SPs 431-1, 431-2, 431-3, respectively.

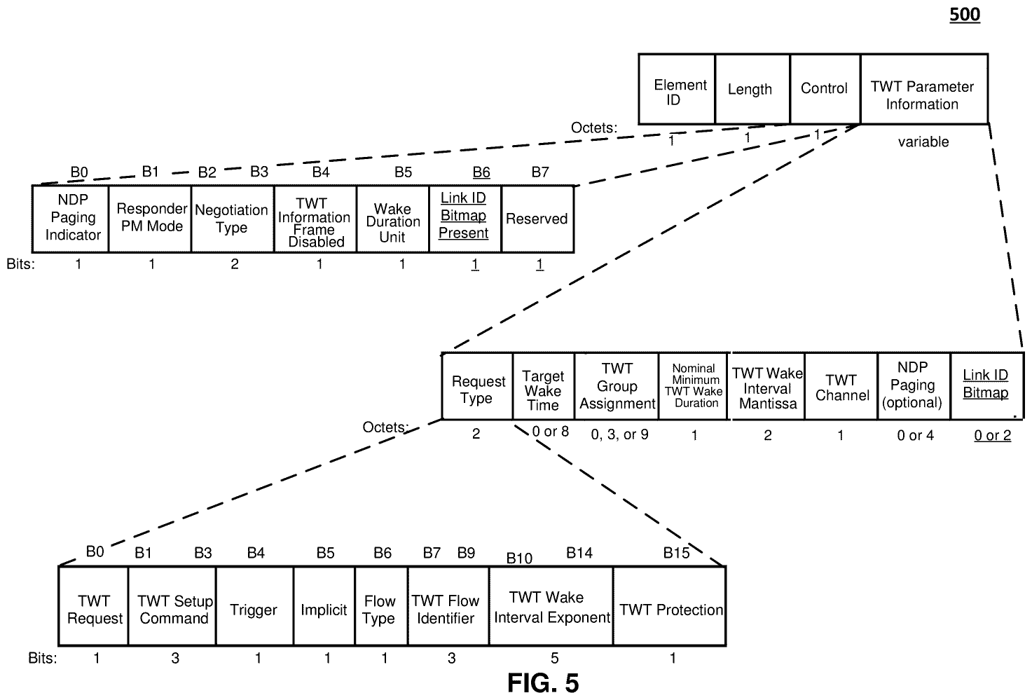

FIG. 5 illustrates an example target wake time (TWT) element 500 which may be used to support individual TWT operation.

In an example, an AP and a STA may use TWT element 500 to negotiate a TWT agreement. The AP and/or the STA may transmit TWT element 500 in an individually addressed management frame. The management frame may be of the type action, action no ack, (re) association request/response, and probe request response, for example.

The TWT schedule and parameters may be provided during a TWT setup phase. Renegotiation/changes of TWT schedules may be signaled via individually addressed frames that contain the updated TWT schedule/parameters. The frames may be management frames as described above or control or data frames that carry a field containing the updated TWT schedule/parameters.

Referring to FIG. 5, TWT element 500 includes an element ID field, a length field, a control field, and a TWT parameter information field.

The element ID field (e.g., 1 octet in length) may indicate that information element 500 is a TWT element. The length field (e.g., 1 octet) may indicate the length of TWT element 500 starting from the control field until an end of TWT element 500. The end of TWT element 500 may be the end of a TWT Channel field or the end of a Link ID bitmap field of the TWT parameter information field.

The TWT parameter information field may include a request type field (e.g., 2 octets), a target wake time field (e.g., 8 octets or less), a TWT group assignment field (e.g., 9, 3, 2, or 0 octets), a nominal minimal TWT wake duration field (e.g., 1 octet), a TWT wake interval mantissa (e.g., 2 octets), a TWT channel field (e.g., 1 octet), an optional NDP paging field (e.g., 0 or 4 octets), and/or a Link ID bitmaps field (e.g., 0 or 2 Octets).

The request type field may indicate a type of TWT request. The request type field may include a TWT request field (e.g., 1 bit), a TWT setup command field (e.g., 3 bits), a trigger field (e.g., 1 bit), an implicit field (e.g., 1 bit), a flow type (e.g., 1 bit), a TWT flow identifier (e.g., 3 bits), a TWT wake interval exponent (e.g., 5 bits), and/or a TWT protection field (e.g., 1 bit).

The TWT request field may indicate whether the TWT element 500 represents a request. If TWT request field has a value of 1, then the TWT element 500 may represent a request to initiate TWT scheduling/setup.

The TWT setup command field may indicate a type of TWT command. In a TWT request, the type of TWT command indicated may be: a request TWT (the TWT responding STA specifies the TWT value; e.g., field set to 0), a suggest TWT (the TWT requesting STA suggests a TWT value; e.g., field set to 1), and a demand TWT (the TWT requesting STA demands a TWT value; e.g., field set to 2).

In a TWT response, the type of TWT command indicated may be: TWT grouping (the TWT responding STA suggests TWT group parameters that are different than the suggested or demanded TWT parameters of the TWT requesting STA; e.g., field set to 3), accept TWT (the TWT responding STA accepts the TWT request with the TWT parameters indicated by the TWT requesting STA; e.g. field set to 4), alternate TWT (the TWT responding STA suggests TWT parameters that are different than the parameters suggested or demanded by the TWT requesting STA; e.g., field set to 5), dictate TWT (the TWT responding STA demands TWT parameters that are different than the parameters suggested or demanded by the TWT requesting STA; e.g., field set to 6), or reject TWT (the TWT responding STA rejects the TWT setup; e.g. field set to 7).

In a TWT response, the TWT command may also indicate an unsolicited response or a broadcast TWT. An unsolicited TWT response is an individually addressed frame that is intended for a specific STA. An unsolicited TWT response may be followed by an ACK frame from the STA receiving the unsolicited TWT response. A broadcast TWT may be intended for multiple STAs and may be carried in a broadcast frame such as, for example, a beacon frame. A broadcast TWT may not be acknowledged by receiving STAs.

An unsolicited TWT response may be used a TWT responding STA to demand that a recipient follow a TWT schedule contained in the TWT element. In an embodiment, an unsolicited TWT response may have the TWT request field set to 0 and a value of ‘dictate TWT’ in the TWT setup command field. A broadcast TWT response may be used by a TWT responding STA to schedule a TWT for any STA that receives and decodes the TWT element.

In certain embodiments, a TWT element, such as TWT element 500, may contain TWT parameter sets for multiple TWT negotiations or indications as described herein. As such, the TWT element may include multiple instances of the Control and the TWT parameter information fields. The TWT flow identifier of the request type field indicates the TWT negotiation which parameters are carried by the TWT parameter information field.

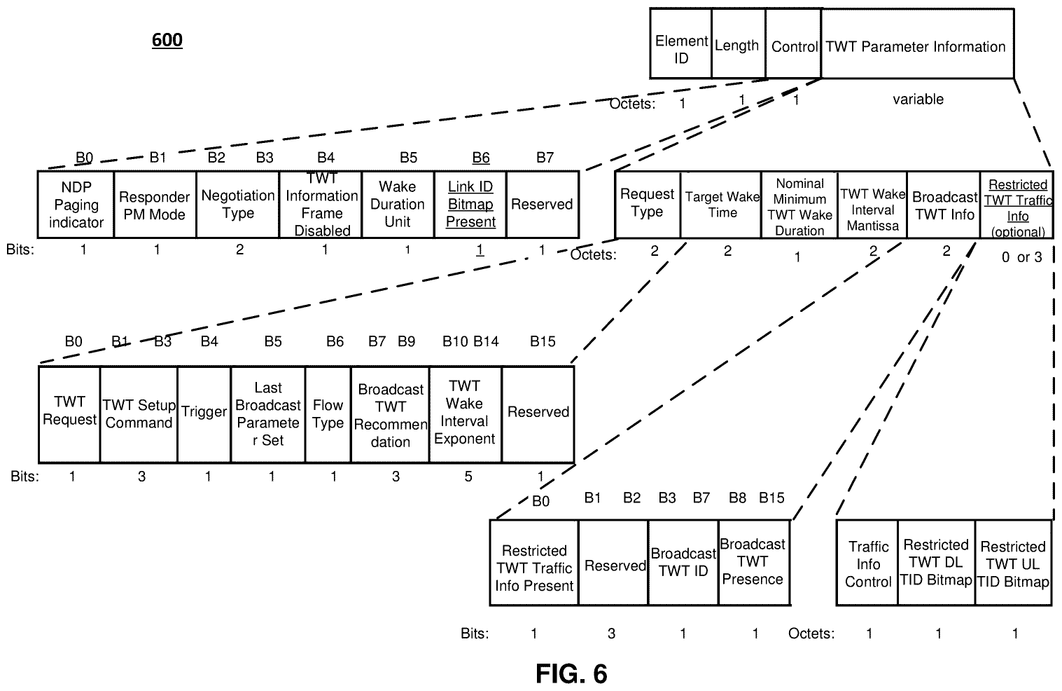

FIG. 6 illustrates an example target wake time (TWT) element 600 which may be used to support restricted TWT (r-TWT) operation. For r-TWT, TWT element 600 may be transmitted in a broadcast management frame, which can be a beacon frame, a TIM broadcast frame, a probe response frame, etc. In this embodiment, TWT element 600 provides non-negotiated TWT schedules (e.g., broadcast TWT schedules).

As shown, TWT element 600 includes an element ID field, a length field, a control field, and a TWT parameter information field.

The element ID field (e.g., 1 octet in length) may indicate that information element 600 is a TWT element. The length field (e.g., 1 octet) may indicate the length of TWT element 600 starting from the control field until an end of TWT element 600. The end of TWT element 600 may be the end of a broadcast TWT info field or the end of a r-TWT traffic info field of the TWT parameter information field.

The TWT parameter information field may include a request type field, a target wake time field (e.g., 2 octets), a nominal minimal TWT wake duration field (e.g., 1 octet), a TWT wake interval mantissa (e.g., 2 octets), a broadcast TWT info field (e.g., 2 octets), and an optional r-TWT traffic info field (e.g., 0 or 3 octets).

The request type field may include, among other fields, a TWT request field, a flow type field, and a TWT wake interval exponent field.

The TWT request field indicates whether TWT element 600 is a request. If the TWT request field has a value of 0, then TWT element 600 may represent a response to a request to initiate TWT scheduling/setup (solicit TWT), an unsolicited TWT response, and/or a broadcast TWT message.

The TWT wake interval represents the average time that a TWT requesting STA or a TWT scheduled STA expects to elapse between successive TWT SP start times of a TWT schedule. The TWT wake interval exponent field indicates a (base 2) exponent used to calculate the TWT wake interval in microseconds. In an embodiment, the TWT wake interval is equal to: (TWT wake interval mantissa)×2^{(TWT Wake Interval Exponent)}. The TWT wake interval mantissa value is indicated in microseconds, base 2 in a TWT wake interval mantissa field of the TWT parameter information field.

The nominal minimum TWT wake duration field may indicate the minimum amount of time (in the unit indicated by a wake duration unit subfield of the control field) that a TWT requesting STA or a TWT scheduled STA is expected to be awake to complete frame exchanges for the period of the TWT wake interval.

The flow type field, in a TWT response that successfully set up a TWT agreement between a TWT requesting STA and a TWT responding STA, may indicate a type of interaction between the TWT requesting STA and the TWT responding STA within a TWT SP of the TWT agreement. A flow type field equal to 0 may indicate an announced TWT. In an announced TWT, the TWT responding STA may not transmit a frame to the TWT requesting STA within a TWT SP until the TWT responding STA receives a PS-Poll frame or a QoS Null frame from the TWT requesting STA. A flow type field equal to 1 may indicate an unannounced TWT. In an unannounced TWT, the TWT responding STA may transmit a frame to the TWT requesting STA within a TWT SP before it has received a frame from the TWT requesting STA.

Within a TWT element that includes a TWT setup command value of ‘request TWT’, ‘suggest TWT’, or ‘demand TWT’, a broadcast TWT ID may indicate a specific broadcast TWT in which the TWT requesting STA is requesting to participate. Within a TWT element that includes a TWT setup command value of ‘accept TWT’, ‘alternate TWT’, ‘dictate TWT’, or ‘reject TWT’, a broadcast TWT ID may indicate a specific broadcast TWT for which the TWT responding STA is providing TWT parameters. The value 0 in the broadcast TWT ID subfield may indicate the broadcast TWT whose membership corresponds to all STAs that are members of the BSS corresponding to the BSSID of the management frame carrying the TWT element and that is permitted to contain trigger frames with random access resource units for unassociated STAs. The Broadcast TWT ID subfield in a r-TWT Parameter set field is always set to a nonzero value.

A broadcast TWT element 600 that contains a r-TWT parameter set is also referred to as a r-TWT element. A r-TWT traffic info present subfield of the broadcast TWT info field may be set to 1 to indicate the presence of the r-TWT traffic info field in TWT element 600. The r-TWT traffic info field is present in a r-TWT parameter set field when the r-TWT traffic info present subfield is set to 1.

The r-TWT traffic info field may include a traffic info control field, a r-TWT DL TID bitmap field, and a r-TWT UL TID bitmap field.

The traffic info control field may include a DL TID bitmap valid subfield and an UL TID bitmap valid subfield. The DL TID bitmap valid subfield indicates if the r-TWT DL TID bitmap field has valid information. When the value of the DL TID bitmap valid subfield is set to 0, it may indicate that DL traffic of TIDs is identified as latency sensitive traffic, and the r-TWT DL TID bitmap field is reserved. The UL TID bitmap valid subfield may indicate if the r-TWT UL TID bitmap field has valid information. When the value of the UL TID bitmap valid subfield is set to 0, it may indicate that UL traffic of TIDs is identified as latency sensitive traffic, and the r-TWT UL TID bitmap field is reserved.

The r-TWT DL TID bitmap subfield and the r-TWT UL TID bitmap subfield may specify which TID(s) are identified by the TWT scheduling AP or the TWT scheduled STA as latency sensitive traffic streams in a downlink and a uplink direction, respectively. A value of 1 at bit position k in the bitmap indicates that TID k is classified as a latency sensitive traffic stream. A value of 0 at bit position k in the bitmap indicates that TID k is not classified as a latency sensitive traffic stream.

An individual target wake time (TWT) may be a specific time or set of times negotiated between two individual stations (e.g., a STA and another STA, or a STA and an AP, etc.) at which the stations may be awake to exchange frames during a service period (SP) of the TWT.

In trigger-enabled TWT, an AP may transmit a trigger frame for scheduling uplink multi-user transmissions from one or more STAs using uplink OFDMA (orthogonal frequency division multiple access) and/or uplink MU-MIMO (multi-user multiple input multiple output) during a trigger-enabled TWT SP. A TWT STA that receives the trigger frame from the AP may transmit a frame to the AP through a resource indicated in the trigger frame during the trigger-enabled TWT SP.

In non-trigger-enabled TWT, an AP may not be required to transmit a trigger frame to schedule uplink multi-user transmissions from one or more STAs during a non-trigger-enabled TWT SP.

In announced TWT, a STA may transmit a frame (e.g., a PS-Poll frame or a QoS null frame) to the AP to retrieve a downlink buffered data from the AP during a TWT SP. In unannounced TWT, an AP may transmit downlink data to a TWT STA without receiving a frame (e.g., a PS-Poll frame, or a QoS null frame) from the TWT STA during a TWT SP.

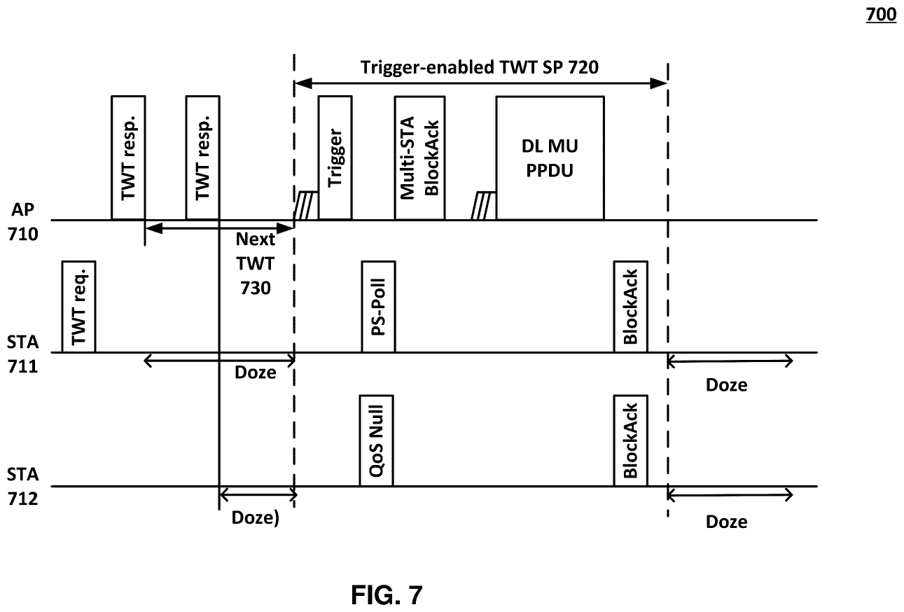

FIG. 7 illustrates an example 700 of individual TWT operation. As shown in FIG. 7, example 700 includes an AP 710, a STA 711, and a STA 712. In an example, AP 710 may be a TWT responding STA and STA 711 and STA 712 may be TWT requesting STAs.

In an example, STA 711 may transmit a TWT request to AP 710 to setup a first trigger-enabled TWT agreement. STA 711 may set a trigger field of the TWT request to 1 to indicate that it is requesting a trigger-enabled TWT. AP 710 may accept the first TWT agreement with STA 711. AP 710 may confirm the acceptance in a TWT response sent to STA 711. The TWT response may indicate a next TWT 730, which indicates the time until a next TWT SP 720 according to the first TWT agreement.

In an example, AP 710 may transmit an unsolicited TWT response to STA 712 to set up a second trigger-enabled TWT agreement with STA 712 without receiving a TWT request from STA 712. The first and second TWT agreements may be set up as announced TWTs.

After the setup of the TWT agreements, STA 711 and STA 712 may enter a doze state until the start of TWT SP 720. During trigger-enabled TWT SP 720, AP 710 may transmit a trigger frame. STA 711 and STA 12 may respond to the trigger frame by indicating that they are in awake state. In an example, STA 711 may transmit a power save poll (PS-Poll) frame. The PS-Poll frame may comprise a BSSID (receiver address: RA) field set to an address of AP 710 and a transmitter address (TA) field set to an address of STA 711. In an example, STA 712 may transmit a QoS null frame in response to the trigger frame. The QoS null frame may comprise a MAC header (e.g., a frame control field, a duration field, address fields, a sequence control field, QoS control field) without a frame body.

In response to the PS-Poll frame and the QoS null frame, AP 710 may transmit a multi-STA Block Ack (M-BA) frame. The M-BA frame may include acknowledgement information associated with the PS-Poll frame and the QoS null frame received from STAs 711 and 712 respectively. Subsequently, STA 711 and STA 712 may receive downlink bufferable units (DL BUs) from AP 710. The DL BUs may include a medium access control (MAC) service data unit (MSDU), an aggregate MAC service data unit (A-MSDU), and/or a bufferable MAC management protocol data unit (MMPDU). STA 711 and STA 712 may transmit Block Ack (BA) frames in response to the DL BUs. At the end of the TWT SP 720, STA 711 and STA 712 may return to a doze state.

A STA may execute individual TWT setup exchanges. The STA may not transmit frames to an AP outside of negotiated TWT SPs. The STA may not transmit frames that are not contained within high efficiency trigger-based physical protocol data units (HE TB PPDUs) to the AP within trigger-enabled TWT SPs. A HE TB PPDU may be transmitted by a STA based on receiving a trigger frame triggering uplink multi-user transmissions.

The AP of a trigger-enabled TWT agreement may schedule for transmission a trigger frame for a STA within the trigger-enabled TWT SP. The STA may transmit an HE TB PPDU as a response to the trigger frame sent during the trigger-enabled TWT SP. A STA that is in power save (PS) mode may include a PS-Poll frame or a QoS null frame in the HE TB PPDU if the TWT is an announced TWT, to indicate to the AP that the STA is currently in the awake state. The AP that receives the PS-Poll frame or the QoS Null frame or any other indication from an STA in PS mode, may deliver to the STA as many buffered BUs as are available at the AP during the TWT SP.

A broadcast target wake time (TWT) may be a specific time or set of times broadcast by an AP to one or more STAs at which the STAs may be awake to exchange frames with the AP during a SP of the TWT.

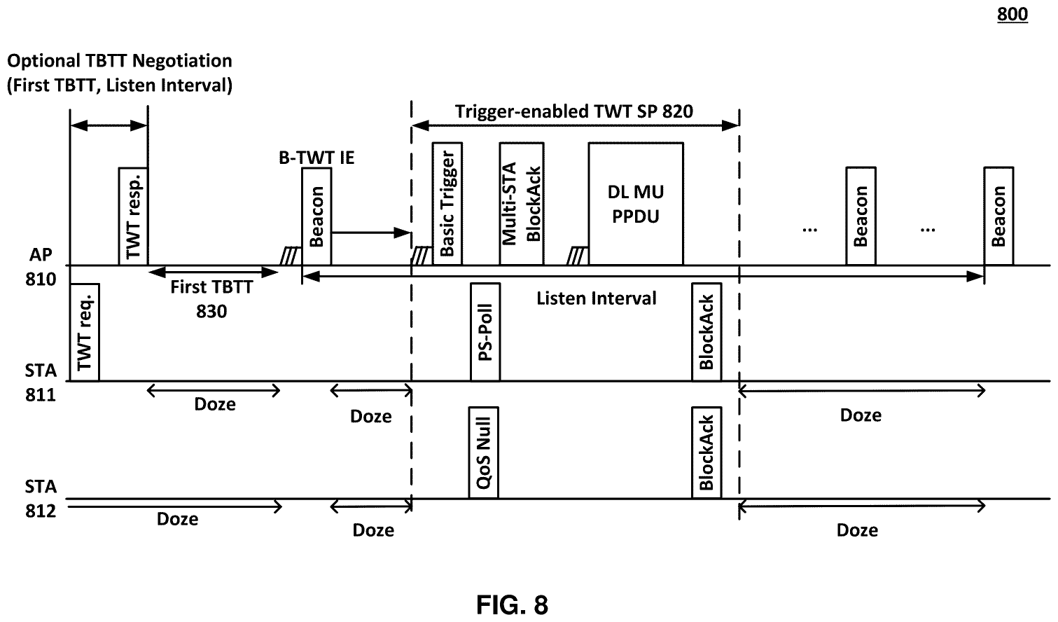

FIG. 8 illustrates an example 800 of broadcast TWT operation. As shown in FIG. 8, example 800 includes an AP 810, a STA 811, and a STA 812. In an example 800, AP 810 may be a TWT scheduling AP and STA 811 and STA 812 may be TWT scheduled STAs.

In an example, AP 810 may include a broadcast TWT element in a beacon frame that indicates a broadcast TWT SP 820. During the broadcast TWT SP 820, AP 810 may transmit trigger frames or DL BUs to STA 811 and STA 812. Beacon frames may be sent by AP 810 at a regular interval defined as the target beacon transmission time (TBTT). The TBTT is a time interval measured in time units (TUs). A TU is equal to 1024 microseconds.

In an example, STA 811 and STA 812 may enter a doze state until the first target beacon transmission time (TBTT). STA 811 and STA 812 may wake up to receive the beacon frame at the first TBTT to determine the broadcast TWT. Upon reception of a broadcast TWT element in a beacon frame, STA 811 and STA 812 may re-enter the doze state until the start of trigger-enabled TWT SP 820.

During trigger-enabled TWT SP 820, AP 810 may transmit a basic trigger frame to STA 811 and STA 812. STA 811 may indicate that it is awake by transmitting a PS-Poll, and STA 812 may indicate that it is awake by transmitting a QoS null frame in response to the basic trigger frame. Subsequently, STA 811 and STA 812 may receive DL BUs from AP 810. STA 811 and STA 812 may return to the doze state outside of the TWT SP 720.

In an example, a STA that intends to operate in power save mode may negotiate a wake TBTT and a wake interval with the AP. For example, as shown in FIG. 8, STA 811 may transmit a TWT request to AP 810 that identifies a wake TBTT of the first beacon frame and a wake interval between subsequent beacon frames. AP 810 may respond with a TWT response to the TWT request confirming the wake TBTT and wake interval. After successfully completing the negotiation, STA 811 may enter a doze state until a first negotiated wake TBTT 830. STA 811 may be in an awake state to listen to the beacon frame transmitted at first negotiated wake TBTT 830. If STA 811 receives a beacon frame from AP 810 at or after TBTT 830, STA 811 may return to the doze state until the next wake TBTT unless a traffic indication map (TIM) element in a beacon frame includes a positive indication for STA 811. The STA 811 may return to the doze state after a nominal minimum TBTT wake duration time has elapsed from the TBTT start time.

A Network Allocation Vector (NAV) is an indicator, maintained by a station (STA), of time periods when transmission onto the wireless medium (WM) may not be initiated by the STA regardless of whether the clear channel assessment (CCA) function of the STA senses that the WM is busy. A STA that receives at least one valid frame in a PSDU may update its NAV with the information from any valid duration field in the PSDU. The STA may update the NAV when a value of the received duration field is greater than the current NAV value of the STA.

A TWT protection is a mechanism employed to protect a TWT session from external STA transmissions. During a TWT SP configured to protect the TWT session, a STA that initiates a transmission opportunity (TXOP) to transmit a frame may transmit a request to transmit (RTS) frame or a clear to transmit (CTS) frame to protect the TWT session by setting the NAV of other STAs based on receiving of the RTS frame and/or the CTS frame. The RTS frame may comprise a frame control field, a duration field, a receiver address (RA) field, a transmitter address (TA) field, and a frame check sequence (FCS) field. The CTS frame may comprise a frame control field, a duration field, a receiver address (RA) field, and a frame check sequence (FCS) field.

The TWT protection field in a TWT element may indicate whether a TWT is protected or unprotected. A TWT requesting STA may set the TWT protection field to 1 to request the TWT responding STA to provide protection for the set of TWT SPs. A TWT protection field equal to 1 may indicate to use a NAV protection mechanism to protect access to the medium during the corresponding TWT SPs.

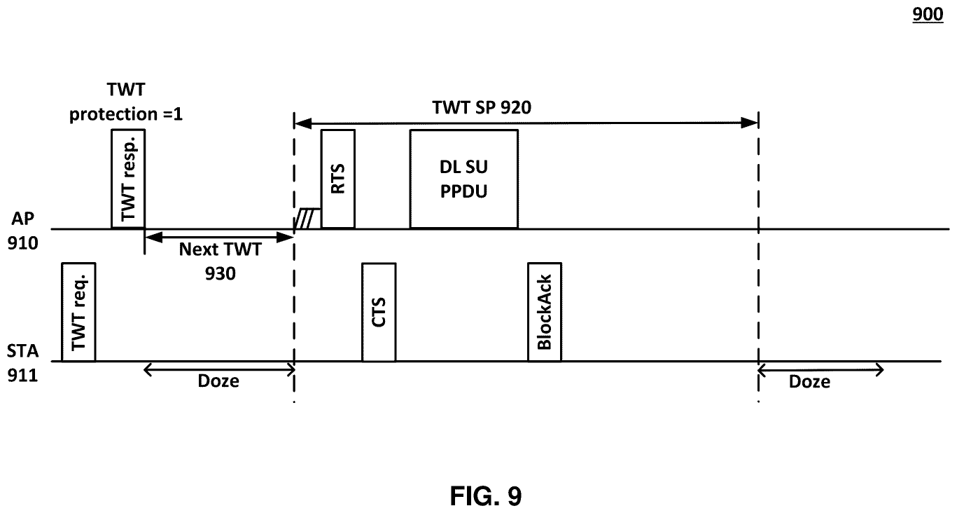

FIG. 9 illustrates an example 900 of TWT protection in individual TWT operation. As shown in FIG. 9, example 900 includes an AP 910 and a STA 911.

In an example, AP 910 may set the TWT protection field to 1 in a TWT response frame to protect the TWT SPs using a NAV protection mechanism. Upon reception of the TWT response frame, STA 911 may enter a doze state until the next TWT 930. AP 910 that has set the TWT protection field to 1 may transmit a NAV setting frame at the start of the TWT SP 920. For example, the NAV setting frame may be an RTS frame or a CTS frame.

A STA that receives the NV setting frame and that is not scheduled to access the medium during the TWT SP 920 may set their NAV according to the NAV setting frame. The STA may not access the medium for the specified amount of time in the NAV setting frame.

STA 911 may be scheduled to access the medium during the TWT SP 920. STA 911 may respond to the RTS frame with a CTS frame. Upon receiving the CTS frame, AP 910 may transmit a downlink frame to STA 911. STA 911 may respond to the downlink frame with a BA frame. When the TWT SP 920 ends, STA 911 may return to the doze state.

In the next Wi-Fi standard, a triggered TXOP sharing procedure may allow an AP to allocate a portion of the time within an obtained TXOP to a STA for transmitting one or more non-trigger-based (non-TB) PPDUs. For the triggered TXOP sharing procedure, the AP may transmit a multi-user request-to-send (MU-RTS) trigger frame with a triggered TXOP sharing mode subfield set to a non-zero value. The MU-RTS trigger frame is a trigger frame for triggering CTS frame(s) from multiple users.

In an example embodiment, an MU-RTS TXS (triggered TXOP sharing) trigger (MRTT) frame is a MU-RTS trigger frame with a triggered TXOP sharing mode subfield set to a non-zero value (e.g., 1 or 2).

In an example, during the portion of the allocated time, the STA may transmit the one or more non-TB PPDUs to the AP. In this case, a triggered TXOP sharing mode subfield in an MU-RTS TXS trigger frame may be set to 1.

In an example, during the portion of the allocated time, the STA may transmit the one or more non-TB PPDUs to the AP or a peer STA. In an example, the peer STA may be a STA with a connection for peer-to-peer (P2P) communication or direct communication with the STA. In this case, a triggered TXOP sharing mode subfield in an MU-RTS TXS trigger frame may be set to 2.

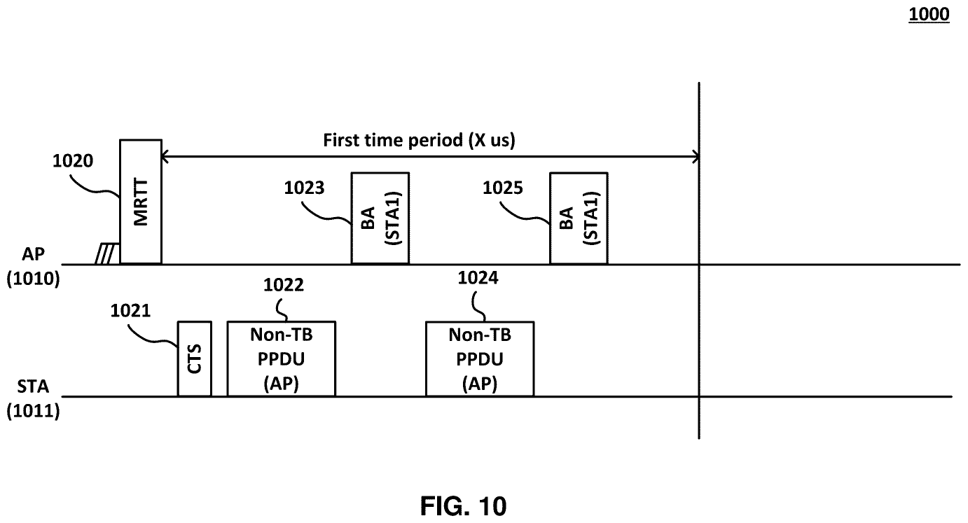

FIG. 10 illustrates an example 1000 of a triggered TXOP sharing (TXS) procedure (Mode=1). As shown in FIG. 10, the procedure may begin by an AP 1010 transmitting an MU-RTS TXS trigger (MRTT) frame 1020 to a STA 1011. MRTT frame 1020 may allocate a portion of an obtained TXOP to STA 1011 and may indicate a triggered TXOP sharing mode equal to 1. STA 1011 receiving MRTT 1020 may use the allocated time duration to transmit one or more non-TB PPDUs 1022, 1024 to AP 1010.

In an example, MRTT frame 1020 may comprise a triggered TXOP sharing mode subfield and/or a first time period.

In an example, the first time period may indicate a portion of a time allocated by AP 1010 within an obtained TXOP. In an example, the first time period may be indicated by a subfield in MRTT frame 1020. In an example, the first time period may be set to a value of X microseconds (us).

In an example, the triggered TXOP sharing mode subfield may be set to 1. The triggered TXOP sharing mode subfield set to 1 may indicate that STA 1011 may transmit one or more non-TB PPDUs to AP 1010 during the first time period. The one or more non-TB PPDUs may comprise a data frame, a control frame, a management frame, or an action frame.

For example, as shown in FIG. 10, MRTT frame 1020 may define a first time period of X us. STA 1011 may transmit non-TB PPDUs 1022, 1024 comprising one or more data frame to AP 1010 during the first time period, preceded by a CTS frame 1021. In an example, AP 1010 may transmit one or more Block Ack (BA) frames 1023, 1025 in response to the one or more data frames contained in non-TB PPDUs 1022, 1024 received from STA 1011.

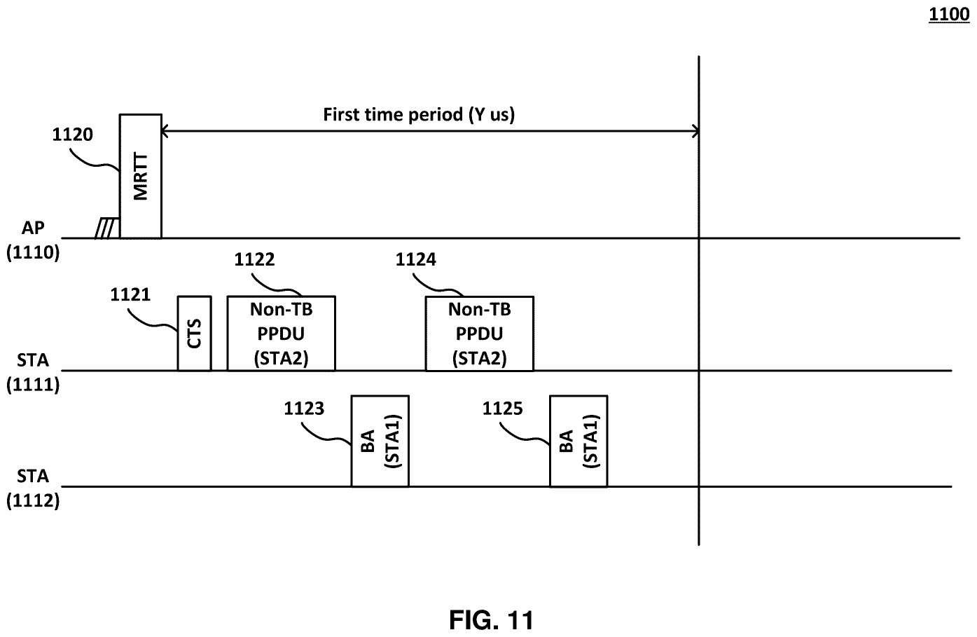

FIG. 11 illustrates an example 1100 of a TXS procedure (Mode=2). As shown in FIG. 11, the procedure may begin by an AP 1110 transmitting an MRTT frame 1120 to a STA 1111. MRTT frame 1120 may allocate a portion of an obtained TXOP to STA 1111 and may indicate a triggered TXOP sharing mode equal to 2. STA1 1111 receiving MRTT 1120 may use the allocated time duration to transmit one or more non-TB PPDUs 1122, 1124 to STA2 1112.

In an example, MRTT frame 1120 may comprise a triggered TXOP sharing mode subfield and/or a first time period.

In an example, the first time period may indicate a portion of a time allocated by AP 1110 within an obtained TXOP. In an example, the first time period may be indicated by a subfield in MRTT frame 1120. In an example, the first time period may be set to a value of Y us.

In an example, the triggered TXOP sharing mode subfield may be set to 2. The triggered TXOP sharing mode subfield set to 2 may indicate that STA 1111 may transmit one or more non-TB PPDUs to AP 1110 or to a peer STA during the first time period. In an example, the peer STA may be a STA with a connection for P2P communication or direct communication with STA 1111. The one or more non-TB PPDUs may comprise a data frame, a control frame, a management frame, or an action frame.

For example, as shown in FIG. 11, MRTT frame 1120 may define a first time period of Y us. STA 1111 may transmit non-TB PPDUs 1122, 1124 comprising one or more data frame to STA 1112 during the first time period, preceded by a CTS frame 1121. In an example, STA 1112 may transmit one or more Block Ack (BA) frames 1123, 1124 in response to the one or more data frames contained in non-TB PPDUs 1122, 1124 received from the STA 1011.

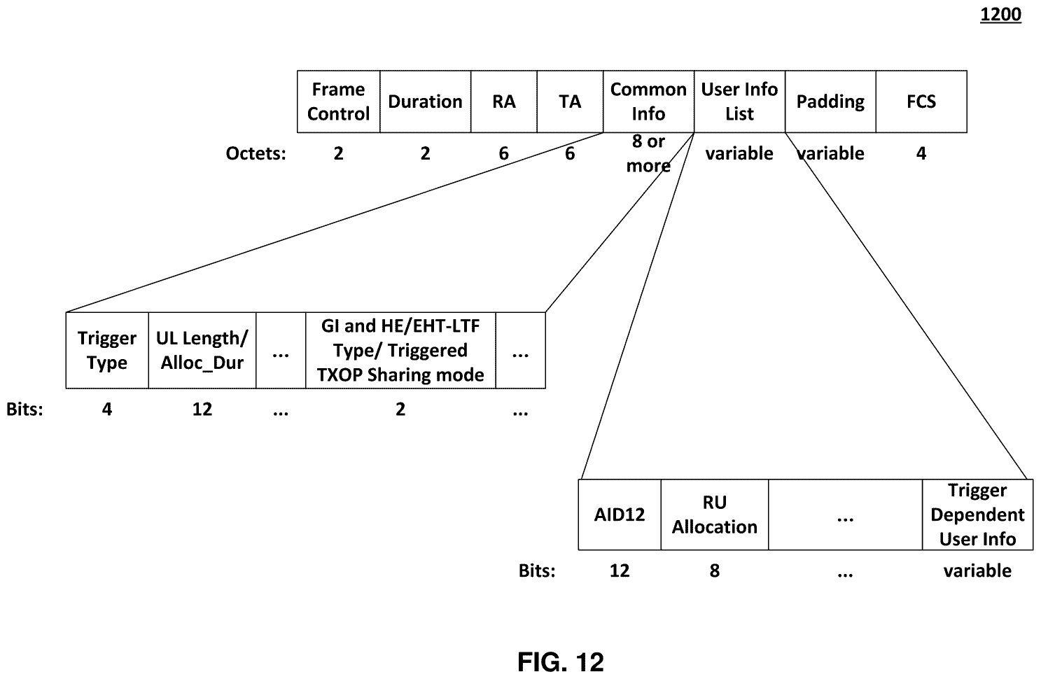

FIG. 12 is an example diagram of an MU-RTS trigger frame which may be used in a TXS procedure.

In an example, the MU-RTS trigger frame may comprise a frame control field, a duration field, a receiver address (RA) field, a transmitter address (TA) field, a common info field, a user info list field, a padding field, and/or frame check sequence (FCS) field.

In an example, the common info field may be a high-efficiency (HE) variant common info field or an extremely high throughput (EHT) variant common info field.

In an example, an EHT variant common info field may comprise one or more of the following subfields: trigger type, UL length/Allocation Duration, more TF, CS required, UL BW, GI and HE/EHT-LTF Type/Triggered TXOP sharing mode, number of HE/EHT-LTF symbols, LDPC extra symbol segment, AP Tx Power, Pre-FEC padding factor, PE disambiguity, UL spatial reuse, HE/EHT P160, special user info field flag, EHT reserved, reserved, or trigger dependent common info.

In an example, the trigger type subfield may indicate an MU-RTS trigger frame.

In an example, the GI and HE/EHT-LTF Type/Triggered TXOP sharing mode subfield may include a triggered TXOP sharing mode subfield (e.g., when the trigger type subfield indicates an MU-RTS trigger frame).

In an example, the triggered TXOP sharing mode subfield may be set to a non-zero value (e.g., 1 or 2).

In an example, the UL length/allocation duration subfield may include an allocation duration subfield (e.g., when the triggered TXOP sharing mode subfield is set to a non-zero value). The allocation duration subfield may indicate a time allocated by an AP transmitting the MU-RTS trigger frame. The allocated time may be a portion of the time of an obtained TXOP by the AP. In an example, the allocation duration subfield may be present in a user info field of the MU-RTS trigger frame instead of the common info field. In an example embodiment, the allocation duration subfield may indicate a first time period.

In an example, the triggered TXOP sharing mode subfield may indicate that a STA indicated by an AID12 subfield (of the user info list field) of the MU-RTS trigger frame may transmit one or more non-TB PPDUs to the AP during the time indicated by the allocation duration subfield. In this case, the triggered TXOP sharing mode subfield may be set to 1.

In an example, the triggered TXOP sharing mode subfield may indicate that a STA indicated by an AID12 subfield of the MU-RTS trigger frame may transmit one or more non-TB PPDUs to the AP or to a peer STA during the time indicated by the allocation duration subfield. In an example, the peer STA may be a STA with a connection for P2P communication or direct communication with the STA. In this case, the triggered TXOP sharing mode subfield may be set to 2.

In an example, the AID12 subfield of the MU-RTS trigger frame may indicate an association identifier (AID) of a STA that may use a time indicated by an allocation duration subfield of the MU-RTS trigger frame.

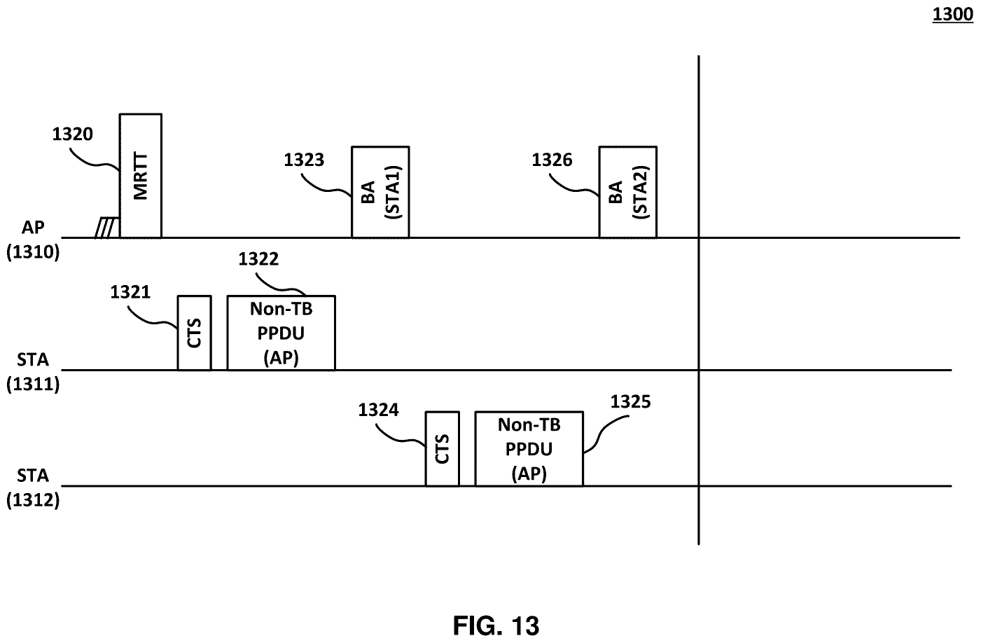

FIG. 13 illustrates an example 1300 of a TXS procedure for allocating time within an obtained TXOP to multiple STAs. In example 1300, a STA 1311 and a STA 1312 may be associated with an AP 1310. As shown, the procedure may begin by AP 1310 transmitting an MRTT frame 1320 to STAs 1311 and 1312. MRTT frame 1320 may allocate a portion of an obtained TXOP to STAs 1311 and 1312. STAs 1311 and 1312 may use the allocated time duration to transmit one or more non-TB PPDUs to AP 1310.

In an example, MRTT frame 1320 may comprise a triggered TXOP sharing mode subfield. In an example, the triggered TXOP sharing mode may be set to 1. In an example, based on the triggered TXOP sharing mode being set to 1, STAs 1311 and 1312 may use the allocated time duration to transmit one or more non-TB PPDUs to AP 1310. For example, as shown in FIG. 13, in response to MRTT frame 1320 having the triggered TXOP sharing mode set to 1, STA 1311 may transmit a CTS frame 1321 followed by a non-TB PPDU 1322 to AP 1310. Similarly, STA 1312 may transmit a CTS frame 1324, followed by a non-TB PPDU 1325 to AP 1310.

The one or more non-TB PPDUs transmitted by STAs 1311 and 1312 may include a data frame, a control frame, a management frame, or an action frame. In example 1300, non-TB PPDUs 1322 and 1325 include data frames. As such, AP 1310 may transmit one or more Block Ack (BA) frames 1323, 1326 respectively in response to the data frames contained in non-TB PPDUs 1322, 1325 received from STAs 1311 and 1312.

In existing technologies, the triggered TXOP sharing mode subfield is provided in a common info field of a MRTT frame. Therefore, the same value (e.g., 1) of the triggered TXOP sharing mode subfield is applied to all STAs. In some WLAN environments however, some STAs may support only the triggered TXOP sharing mode 1 while other STAs may support only the triggered TXOP sharing mode 2. In such environments, applying a common value of a triggered TXOP sharing mode subfield to all STAs scheduled by the MRTT frame can reduce the scheduling flexibility and the scheduling efficiency of the AP.

In example embodiments, an AP may allocate a time portion within an obtained TXOP to a plurality of STAs, with a respective value per STA of the triggered TXOP sharing mode. The respective value per STA may be identical or different among the allocated STAs.

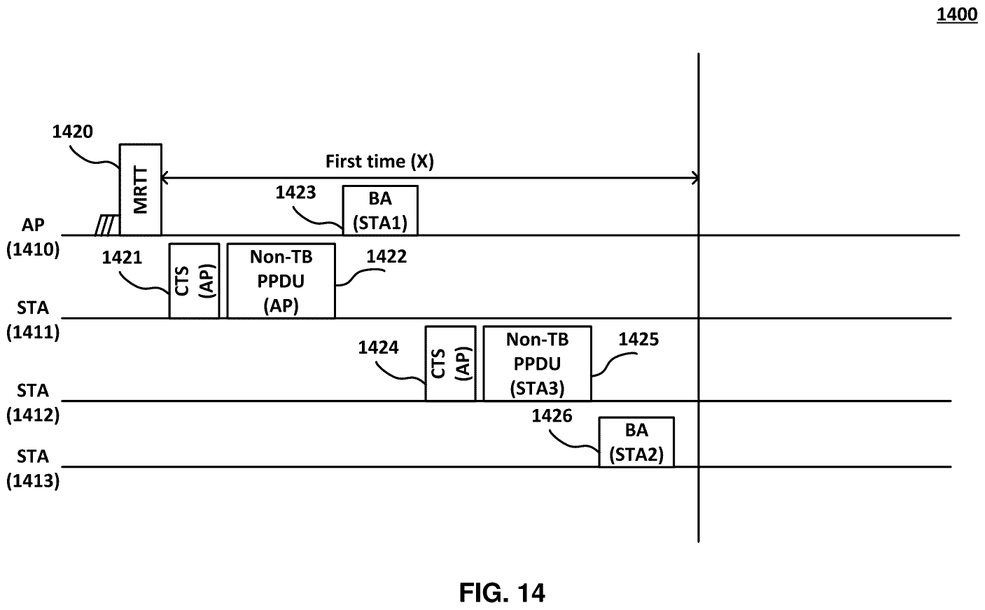

FIG. 14 illustrates an example 1400 of a TXS procedure for allocating time within an obtained TXOP to multiple STAs, with a respective triggered TXOP sharing mode indicated per STA. As shown, example 1400 may include an AP 1410 and a plurality of STAs 1411, 1412, and 1413. In an example, STAs 1411 and 1412 may be associated with AP 1410, while STA 1413 may not be associated with AP 1410.

As shown in FIG. 14, the procedure may begin by AP 1410 transmitting MRTT frame 1420. MRTT frame 1420 may allocate a time portion of an obtained TXOP to STAs 1411 and 1412 respectively. In an example, MRTT frame 1420 may indicate a respective triggered TXOP sharing mode for each of STAs 1411 and 1412.

In an example, MRTT frame 1420 may comprise a common info field.

In an example, MRTT frame 1420 may comprise a plurality of user info fields corresponding to a plurality of STAs, including STAs 1411 and 1412.

In an example, the plurality of user info fields may each include a triggered TXOP sharing mode subfield. A triggered TXOP sharing mode subfield of a user info field may indicate a TXS operation mode of a respective STA. The respective STA may be indicated by an AID12 subfield of the user info field.

In an example, a triggered TXOP sharing mode subfield of a user info field corresponding to STA 1411 may be set to 1 to indicate a Triggered TXOP sharing mode 1 for STA 1411, while a triggered TXOP sharing mode subfield of a user info field corresponding to STA 1412 may be set to 2 to indicate a Triggered TXOP sharing mode 2 for STA 1412.

In an example, the indication of a triggered TXOP sharing mode 1 for a STA in an MU-RTS TXS trigger frame may indicate that the STA may transmit a non-TB PPDU to an AP transmitting the MU-RTS TXS trigger frame, in a time allocation for the STA. The STA for which the triggered TXOP sharing mode is indicated in the MU-RTS TXS trigger frame may be indicated by an AID12 subfield of a user info field of the MU-RTS TXS trigger frame.

In an example, the indication of a triggered TXOP sharing mode 2 for a STA in an MU-RTS TXS trigger frame may indicate that the STA may transmit a non-TB PPDU to an AP transmitting the MU-RTS TXS trigger frame or to another STA, in a time allocation for the STA. The STA for which the triggered TXOP sharing mode is indicated in the MU-RTS TXS trigger frame may be indicated by an AID12 subfield of a user info field of the MU-RTS trigger frame. The other STA may be a peer STA that has a direct connection with the STA indicated by the AID12 subfield.

In example 1400, in response to MRTT frame 1420, STA 1411 may transmit a CTS frame 1421, followed by a non-TB PPDU 1422, in a respective time allocation for STA 1411. Similarly, STA 1412 may transmit a CTS frame 1424, followed by a non-TB PPDU 1425, in a respective time allocation for STA 1412.

In an example, STA 1411 may transmit non-TB PPDU 1422 to AP 1410 based on a triggered TXOP sharing mode subfield, of a user info field corresponding to STA 1411, being set to 1. In an example, STA 1411 may receive a Block Ack (BA) frame 1423, in response to non-TB PPDU 1422, from AP 1410.

In an example, STA 1412 may transmit non-TB PPDU 1425 to STA 1413 based on a triggered TXOP sharing mode subfield, of a user info field corresponding to STA 1412, being set to 2. In an example, STA 1412 may receive a Block Ack (BA) frame 1426, in response to non-TB PPDU 1425, from STA 1413.

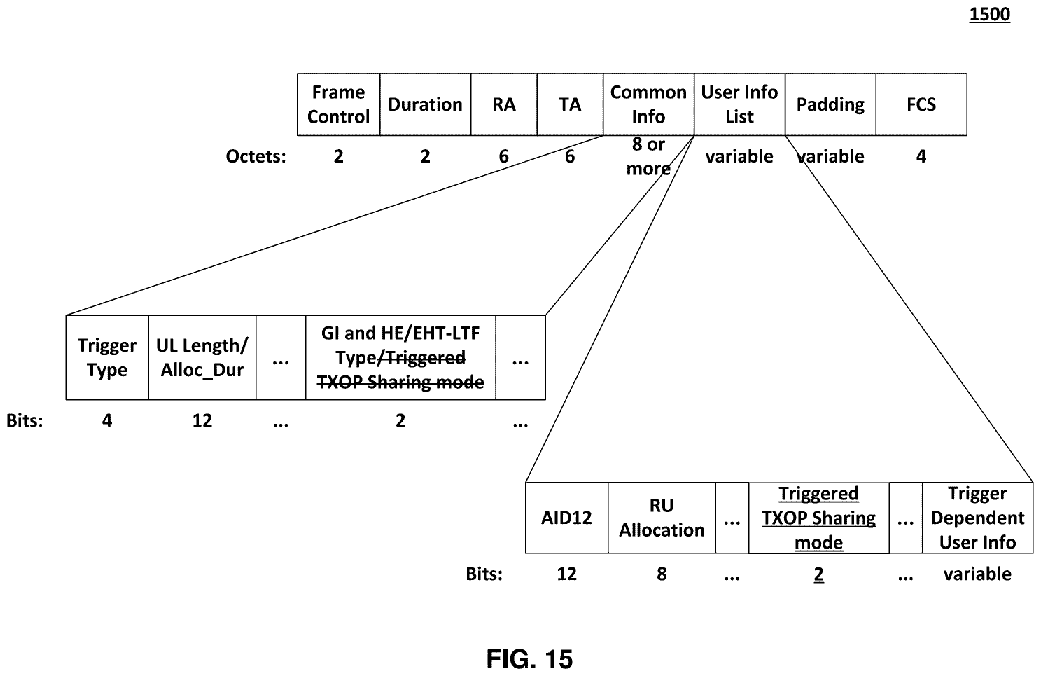

FIG. 15 illustrates an example of MU-RTS TXS trigger frame 1500 which may be used in a TXS procedure for allocating time within an obtained TXOP to multiple users.

As shown in FIG. 15, MU-RTS TXS trigger frame 1500 may include a common info field and a user info list field. The user info list may include one or more user info fields. A user info field of the one or more user info fields may include an association identifier 12 (AID12) subfield, an RU allocation subfield, and a triggered TXOP sharing mode subfield.

In an example, the triggered TXOP sharing mode subfield of a user info field may indicate a TXS operation mode (e.g., triggered TXOP sharing mode 1 or triggered TXOP sharing mode 2) of a STA indicated by an AID12 subfield of the user info field. The triggered TXOP sharing mode subfield may be set to 1 to indicate a triggered TXOP sharing mode 1. The triggered TXOP sharing mode subfield may be set to 2 to indicate a triggered TXOP sharing mode 2.

In an example, a common info field of the MU-RTS trigger frame 1500 may not include a triggered TXOP sharing mode subfield.

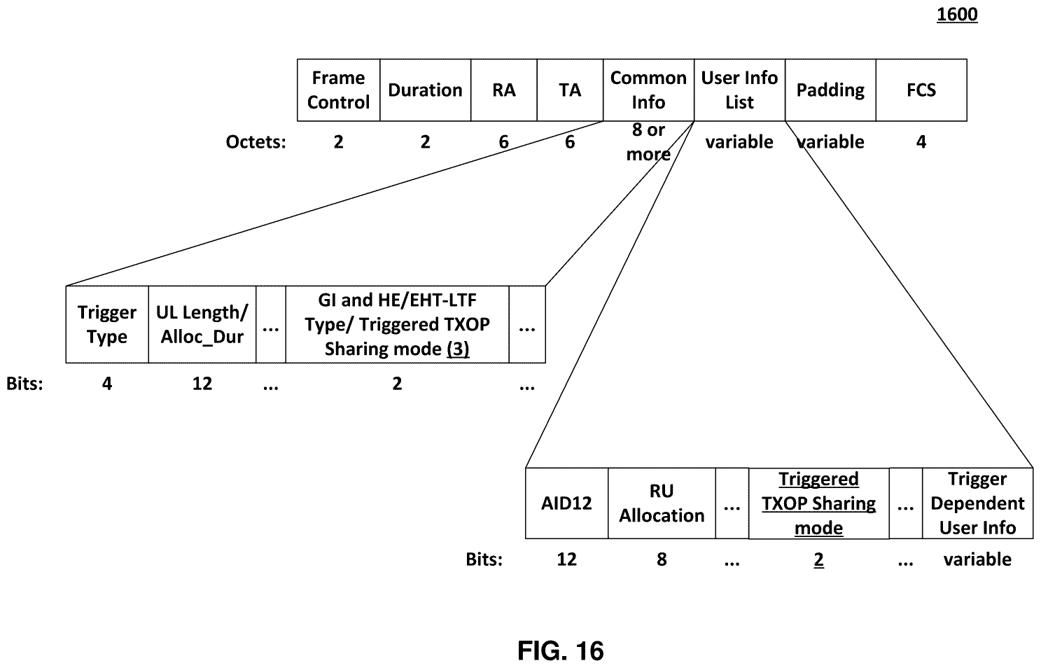

FIG. 16 illustrates another example MU-RTS trigger frame 1600 which may be used in a TXS procedure for allocating time within an obtained TXOP to multiple users.

As shown in FIG. 16, MU-RTS trigger frame 1600 may include a common info field and a user info list field.

In an example, a common info field of the MU-RTS trigger frame may include a Triggered TXOP sharing mode subfield.

The user info list field may include one or more user info fields. A user info field of the one or more user info fields may include an AID12 subfield and an RU allocation subfield.

In an example, a user info field of the one or more user info fields may include a triggered TXOP sharing mode subfield when a triggered TXOP sharing mode subfield of the common info field is set to 3.

In an example, a user info field of the one or more user info fields may include a triggered TXOP sharing mode subfield when a respective subfield of the common info field is set to 1. The respective subfield of the common info field may indicate whether TXS mode is present for the user corresponding to the user info field. In an embodiment, where the common info field is an HE variant common info field, the respective subfield of the common info field may be located in bit 63 of the common info field. In another embodiment, where the common info field is an EHT variant common info field, the respective subfield of the common info field may be located in one of bit 22, bit 26, bit 53, or bit 63 of the common info field.

In an example embodiment, a common info field may not comprise a triggered TXOP sharing mode subfield when the respective subfield is set to 1.

In an example, the triggered TXOP sharing mode subfield of a user info field may indicate a TXS operation mode (e.g., triggered TXOP sharing mode 1 or triggered TXOP sharing mode 2) of a STA indicated by an AID12 subfield of the user info field. The triggered TXOP sharing mode subfield of the user info field may be set to 1 to indicate a triggered TXOP sharing mode 1. The triggered TXOP sharing mode subfield of the user info field may be set to 2 to indicate a triggered TXOP sharing mode 2.

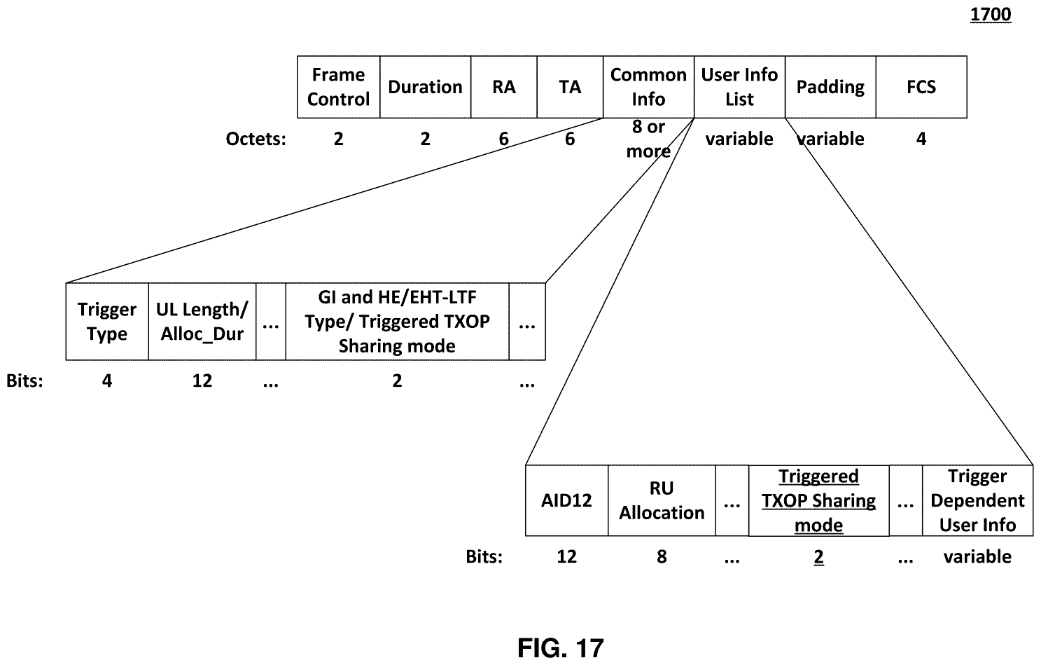

FIG. 17 illustrates another example MU-RTS trigger frame 1700 which may be used in a TXS procedure for allocating time within an obtained TXOP to multiple users.

As shown in FIG. 17, MU-RTS trigger frame 1700 may comprise a common info field and a user info list field.

In an example, a common info field of the MU-RTS trigger frame may comprise a Triggered TXOP sharing mode subfield.

The user info list may comprise one or more user info fields. A user info field of the one or more user info fields may comprise an AID12 subfield and an RU allocation subfield.

In an example, a user info field of the one or more user info fields may comprise a triggered TXOP sharing mode subfield.

In an example, the triggered TXOP sharing mode subfield of the user info field may indicate a TXS operation mode (e.g., triggered TXOP sharing mode 1 or triggered TXOP sharing mode 2) of a STA indicated by an AID12 subfield of the user info field. The triggered TXOP sharing mode subfield of the user info field may be set to 1 to indicate a triggered TXOP sharing mode 1. The triggered TXOP sharing mode subfield of the user info field may be set to 2 to indicate a triggered TXOP sharing mode 2.

In an example, a value of a triggered TXOP sharing mode subfield in a user info field may override a value of a triggered TXOP sharing mode subfield in a common info field for a STA indicated by an AID12 subfield of the user info field.

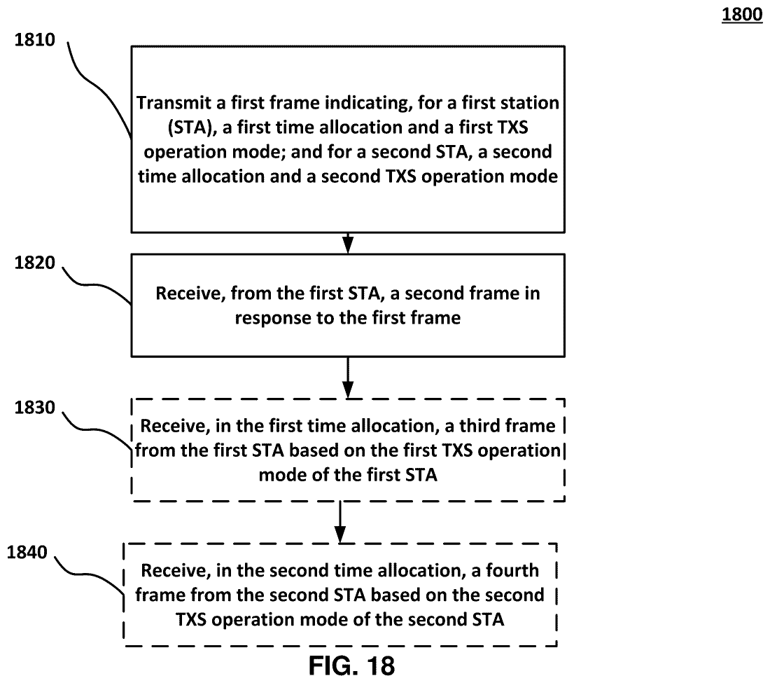

FIG. 18 illustrates a flowchart of a process 1800 which may be used by an AP in a TXS procedure. The AP may be affiliated with an AP MLD.

As shown in FIG. 18, process 1800 may include, in step 1810, transmitting a first frame indicating, for a first STA, a first time allocation and a first TXS operation mode and for a second STA, a second time allocation and a second TXS operation mode.

In an embodiment, the first STA and the second STA are associated with the AP. In an embodiment, at least one of the first and second STA may be affiliated with a non-AP MLD.

In an embodiment, the first frame may be an MU-RTS TXS trigger frame.

In an embodiment, the first TXS operation mode is of a different type than the second TXS operation mode.

In an embodiment, each of the first and second STAs supports a triggered TXOP sharing mode 1 and/or a triggered TXOP sharing mode 2.

In an embodiment, at least one of the first and second TXS operation modes corresponds to a triggered TXOP sharing mode 1 or a triggered TXOP sharing mode 2. A triggered TXOP sharing mode 1 may indicate that a STA indicated in the first frame may transmit one or more non-TB PPDUs to the AP in a respective time allocation indicated in the first frame. A triggered TXOP sharing mode 2 may indicate that a STA indicated in the first frame may transmit one or more non-TB PPDUs to the AP or to another STA in a respective time allocation indicated in the first frame.

In an embodiment, the first frame includes a first user info field which includes the first TXS operation mode, and a second user info field which includes the second TXS operation mode.

In an embodiment, the first frame includes a common info field. In an embodiment, a value of a subfield of the common info field indicates whether, a first user info field of the first frame comprises the first TXS operation mode; and a second user info field of the first frame comprises the second TXS operation mode.

In an embodiment, the subfield of the common info field may correspond to a triggered TXOP sharing mode subfield in the common info field. When a value of the triggered TXOP sharing mode subfield in the common info field is equal to 3, the first user info field may comprise the first triggered TXOP sharing mode subfield and the second user info field may comprise the second triggered TXOP sharing mode subfield.

In an example, a user info field of the one or more user info fields may include a triggered TXOP sharing mode subfield when a respective subfield of the common info field is set to 1. The respective subfield of the common info field may indicate whether TXS mode is present for the user corresponding to the user info field. In an embodiment, where the common info field is an HE variant common info field, the respective subfield of the common info field may be located in bit 63 of the common info field. In another embodiment, where the common info field is an EHT variant common info field, the respective subfield of the common info field may be located in one of bit 22, bit 26, bit 53, or bit 63 of the common info field.

In step 1820, process 1800 may include receiving from the first STA a second frame in response to the first frame. The second frame may be a CTS frame.

Optionally, in step 1830, process 1800 may include receiving, in the first time allocation, a third frame from the first STA based on the first TXS operation mode of the first STA. The third frame may include a data frame, a management frame, a control frame, or an action frame.

In another embodiment, process 1800 may not include step 1830. Instead, the first time allocation may be used by the first STA to transmit a third frame to a third STA, based on the first TXS operation mode. The third STA may be associated with the AP. The third STA may not be associate with the AP. The third STA may be a peer STA that has a direct connection with the first STA.

Optionally, in step 1840, process 1800 may include receiving, in the second time allocation, a fourth frame from the second STA based on the second TXS operation mode of the second STA.

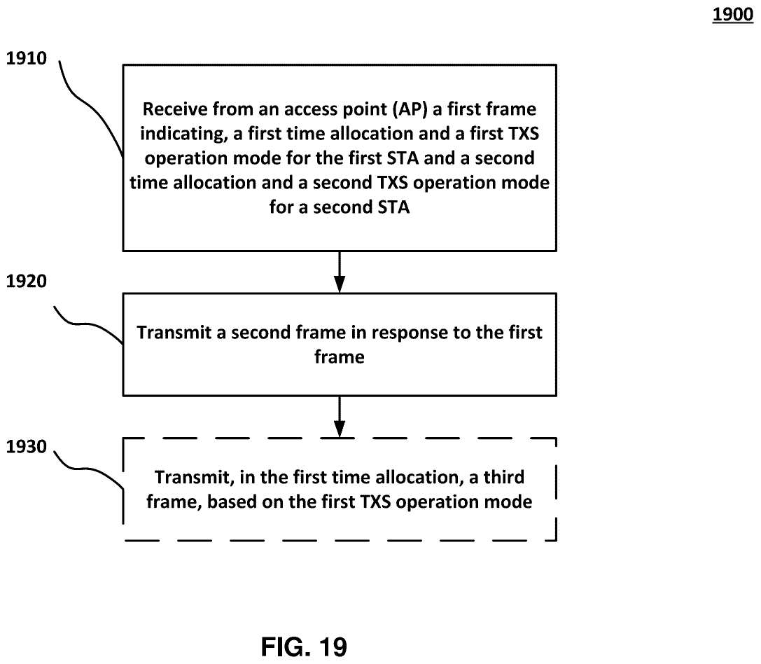

FIG. 19 illustrates a flowchart of a process 1900 which may be used by a STA in a TXS procedure. In an embodiment, process 1900 may be performed by a first STA. The first STA may be associated with an AP, with which a second STA may also be associated. A third STA may be in communication range with the first STA. The third STA may or may not be associated with the AP. The third STA may be a peer STA with which the first STA has a direct connection.

As shown in FIG. 19, process 1900 may include, in step 1910, receiving, from an AP, a first frame indicating a first time allocation and a first TXS operation mode for the first STA and a second time allocation and a second TXS operation mode for a second STA.

In an embodiment, at least one of the first and second STA may be affiliated with a non-AP MLD.

In an embodiment, the first frame may be an MU-RTS TXS trigger frame.

In an embodiment, the first TXS operation mode may be of a different type than the second TXS operation mode.

In an embodiment, each of the first and second STAs supports a triggered TXOP sharing mode 1 and/or a triggered TXOP sharing mode 2.

In an embodiment, at least one of the first and second TXS operation modes corresponds to a triggered TXOP sharing mode 1 or a triggered TXOP sharing mode 2. A triggered TXOP sharing mode 1 may indicate that a STA indicated in the first frame may transmit one or more non-TB PPDUs to the AP in a respective time allocation indicated in the first frame. A triggered TXOP sharing mode 2 may indicate that a STA indicated in the first frame may transmit one or more non-TB PPDUs to the AP or to another STA in a respective time allocation indicated in the first frame.

In an embodiment, the first frame includes a first user info field which includes the first TXS operation mode, and a second user info field which includes the second TXS operation mode.

In an embodiment, the first frame includes a common info field. In an embodiment, a value of a subfield of the common info field indicates whether, a first user info field of the first frame comprises the first TXS operation mode; and a second user info field of the first frame comprises the second TXS operation mode.

In an embodiment, the subfield of the common info field may correspond to a triggered TXOP sharing mode subfield in the common info field. When a value of the triggered TXOP sharing mode subfield in the common info field is equal to 3, the first user info field may comprise the first triggered TXOP sharing mode subfield and the second user info field may comprise the second triggered TXOP sharing mode subfield.

In an example, a user info field of the one or more user info fields may include a triggered TXOP sharing mode subfield when a respective subfield of the common info field is set to 1. The respective subfield of the common info field may indicate whether TXS mode is present for the user corresponding to the user info field. In an embodiment, where the common info field is an HE variant common info field, the respective subfield of the common info field may be located in bit 63 of the common info field. In another embodiment, where the common info field is an EHT variant common info field, the respective subfield of the common info field may be located in one of bit 22, bit 26, bit 53, or bit 63 of the common info field.

In step 1920, process 1900 may include transmitting to the AP a second frame in response to the first frame. In an embodiment, the second frame may be a CTS frame.

Optionally, in step 1930, process 1900 may include transmitting, in the first time allocation, a third frame based on the first TXS operation mode. Depending on the first TXS operation mode, the third frame may be transmitted to the AP or to the third STA.

1. An access point (AP) comprising:
one or more processors; and
memory storing instructions that, when executed by the one or more processors, cause the AP to:
transmit a first frame indicating:
for a first station (STA), a first time allocation of a transmission opportunity (TXOP) obtained by the AP and a first triggered TXOP sharing (TXS) mode; and
for a second STA, a second time allocation of the TXOP and a second TXS mode; and
receive, from the first STA, a second frame within the first time allocation in response to the first frame.

2. The AP of claim 1, wherein the first TXS mode is of a different type than the second TXS mode.

3. The AP of claim 1, wherein the first frame comprises a multi-user request-to-send TXS (MU-RTS TXS) trigger frame.

4. The AP of claim 1, wherein the first frame comprises:
a first user info field indicating the first TXS mode; and
a second user info field indicating the second TXS mode.

5. The AP of claim 1, wherein the first frame comprises a first user info field and a second user info field, and wherein a common info field of the first frame indicates whether:
the first user info field indicates the first TXS mode; and
the second user info field indicates the second TXS mode.

6. The AP of claim 1, wherein the second frame comprises a clear-to-send (CTS) frame.

7. The AP of claim 1, wherein the first TXS mode and the second TXS mode each corresponds to a TXS mode 1 or a TXS mode 2.

8. The AP of claim 7, wherein the first TXS mode corresponds to a TXS mode 1 or a TXS mode 2, and wherein the instructions, when executed by the one or more processors, further cause the AP to receive, in the first time allocation, a third frame from the first STA.

9. The AP of claim 1, wherein the instructions, when executed by the one or more processors, further cause the AP to receive, from the second STA, a fourth frame within the second time allocation in response to the first frame.

10. A first station (STA) comprising:
one or more processors; and
memory storing instructions that, when executed by the one or more processors, cause the first STA to:
receive, from an access point (AP), a first frame indicating:
for the first STA, a first time allocation of a transmission opportunity (TXOP) obtained by the AP and a first triggered TXOP sharing (TXS) mode; and
for a second STA, a second time allocation of the TXOP and a second TXS mode; and
transmit a second frame within the first time allocation in response to the first frame.

11. The first STA of claim 10, wherein the first TXS mode is of a different type than the second TXS mode.

12. The first STA of claim 10, wherein the first frame comprises a multi-user request-to-send TXS (MU-RTS TXS) trigger frame.

13. The first STA of claim 10, wherein the first frame comprises:
a first user info field indicating the first TXS mode; and
a second user info field indicating the second TXS mode.

14. The first STA of claim 10, wherein the first frame comprises a first user info field and a second user info field, and wherein a common info field of the first frame indicates whether:
the first user info field indicates the first TXS mode; and
the second user info field indicates the second TXS mode.

15. The first STA of claim 10, wherein the second frame comprises a clear-to-send (CTS) frame.

16. The first STA of claim 10, wherein the first TXS mode and the second TXS mode each corresponds to a TXS mode 1 or a TXS mode 2.

17. The first STA of claim 16, wherein the first TXS mode corresponds to the TXS mode 1 or the TXS mode 2, and wherein the instructions, when executed by the one or more processors, further cause the first STA to transmit, in the first time allocation, a third frame to the AP or to a third STA.

18. The first STA of claim 17, wherein the third STA has a direct connection with the first STA.

19. A non-transitory computer-readable medium comprising instructions that, when executed by one or more processors of an access point (AP), cause the AP to:
transmit a first frame indicating:
for a first station (STA), a first time allocation of a transmission opportunity (TXOP) obtained by the AP and a first triggered TXOP sharing (TXS) mode; and
for a second STA, a second time allocation of the TXOP and a second TXS mode; and
receive, from the first STA, a second frame within the first time allocation in response to the first frame.

20. The non-transitory computer-readable medium of claim 19, wherein the first TXS mode is of a different type than the second TXS mode.
